(19) United States
(12) Patent Application Publication
(10) Pub. No.: US 2019/0207495 A1
(43) Pub. Date: Jul. 4, 2019

(54) ROTOR MAGNETIC COMPONENT STRUCTURE AND FAN MOTOR DEVICE THEREOF

(71) Applicant: ASIA VITAL COMPONENTS CO., LTD., New Taipei City (TW)

(72) Inventors: Yen-Chih Lu, New Taipei City (TW); Chun-Liang Ho, New Taipei City (TW)

(21) Appl. No.: 16/232,024

(22) Filed: Dec. 25, 2018

Related U.S. Application Data
(63) Continuation of application No. 14/616,748, filed on Feb. 9, 2015.

(51) Int. Cl. H02K 29/08; H02K 1/27

(52) U.S. Cl. CPC H02K 29/08; H02K 1/2786

(57) ABSTRACT

A rotor magnetic component structure and a fan motor device thereof. The fan motor device includes a stator having a radial magnetic face and a sensor member disposed under the stator. The rotor magnetic component structure includes a main body composed of multiple N poles and multiple S poles, which are alternately arranged. A magnetic force border line is formed between each N pole and each S pole. The magnetic force border line includes a first vertical section corresponding to the radial magnetic face of the stator and an inclined section obliquely extending from a lower end of the first vertical section corresponding to the sensor member. The rotor magnetic component structure is able to reduce the vibration caused in the commutation of the magnetic poles and the sensor member can find the best commutation point.

The present application is a continuation of U.S. patent application Ser. No. 14/616,748, filed on Feb. 9, 2015.

### BACKGROUND OF THE INVENTION

### 1. Field of the Invention

The present invention relates generally to a rotor magnetic component structure, and more particularly to a rotor magnetic component structure applied to a fan motor.

### 2. Description of the Related Art

The basic structure of a conventional brushless direct-current fan motor includes a stator and a rotor. The motor is rotated in such a manner that two magnetic field bodies perpendicularly interact on each other to rotate the rotor. Therefore, basically, the motor needs to have two magnetic field sources to produce magnetic fields. Basically, the two magnetic field sources are designed from electromagnet and permanent magnet. The design manners of the electromagnet and permanent magnet can be substantially classified into two parts, that is, stationary and rotational parts. The stationary part means the stator including a shaft, armature core and armature winding. The stator mainly functions to produce magnetic field to interact with the magnetic field of the external permanent magnet and create rotational torque. The rotational part means the rotor including a permanent magnet and fan impeller. The magnetic fields interact on each other to produce rotational torque for driving the fan impeller to rotate.

The current brushless direct-current fan motor employs electronic commutation technique to receive the rotational position signals of the rotor and tell the stator the commutation time so that the rotor can continuously rotate. The component for receiving the rotational position signals of the rotor is generally a Hall sensor. The Hall sensor senses the commutation time of the N-S poles of the rotor to urge the drive circuit to drive and rotate the rotor. Currently, the permanent magnet of the rotor is magnetized by means of normal magnetization (inclination is zero) or oblique magnetization. The more often used normal magnetization is performed with the Hall sensor cooperatively moved to find the best efficiency point. However, due to the structural limitation of the mechanism, the best commutation point often cannot found. This will lead to vibration. To overcome the above problem, oblique magnetization is employed to reduce the vibration caused in the commutation. However, this will sacrifice the efficiency of the motor and lead to poor rotational efficiency of the motor.

According to the above, the current fan motor can be hardly designed with both the improvement of vibration problem and enhancement of the performance taken into consideration. It is therefore tried by the applicant to provide a rotor magnetic component structure, which not only can reduce the vibration caused in the commutation of the magnetic poles, but also can enhance the rotational performance.

### SUMMARY OF THE INVENTION

It is therefore a primary object of the present invention to provide a rotor magnetic component structure having a magnetic force border line with complex structure.

It is a further object of the present invention to provide the above rotor magnetic component structure, which is able to reduce the vibration caused in the commutation of the magnetic poles and maintain the efficiency of the motor to overcome the structural limitation of the conventional mechanism and enable the sensor member can find the best commutation point.

It is still a further object of the present invention to provide a fan motor device, which is able to reduce the vibration caused in the commutation of the magnetic poles and maintain the efficiency of the motor to overcome the structural limitation of the conventional mechanism and enable the sensor member can find the best commutation point.

To achieve the above and other objects, the rotor magnetic component structure of the present invention includes a main body composed of multiple N poles and multiple S poles, which are alternately arranged, a magnetic force border line being formed between each N pole and each S pole, the magnetic force border line including a first vertical section and an inclined section obliquely extending from a lower end of the first vertical section.

Still to achieve the above and other objects, the fan motor device of the present invention includes: a stator having a radial magnetic face, a circuit board being connected under the stator, at least one sensor member being disposed on the circuit board; and a rotor corresponding to the stator, the rotor including a magnetic component, the magnetic component having a main body composed of multiple N poles and multiple S poles, which are alternately arranged, a magnetic force border line being formed between each N pole and each S pole, the magnetic force border line including a first vertical section corresponding to the radial magnetic face of the stator and an inclined section obliquely extending from a lower end of the first vertical section in adjacency to the sensor member.

In the above rotor magnetic component structure, the lower end of the first vertical section has a first turning section positioned between the first vertical section and the inclined section.

In the above rotor magnetic component structure, a first angle is contained between the first vertical section and the inclined section.

In the above rotor magnetic component structure, the magnetic force border line further includes a second vertical section downward vertically extending from a lower end of the inclined section.

In the above rotor magnetic component structure, the lower end of the inclined section has a second turning section positioned between the inclined section and the second vertical section.

In the above rotor magnetic component structure, a second angle is contained between the inclined section and the second vertical section.

In the above rotor magnetic component structure, the inclined section is inclined in a rotational direction of the main body.

In the above rotor magnetic component structure, the main body has an upper side and a lower side, a first region and a second region under the first region being defined between the upper and lower sides, whereby the first region radially corresponds to a radial magnetic face of a stator and the second region does not correspond to the radial magnetic face of the stator, the first vertical section being positioned in the first region, the inclined section being positioned in the second region.

In the above rotor magnetic component structure, the main body has an upper side and a lower side, a first region and a second region under the first region being defined between the upper and lower sides, whereby the first region radially corresponds to a radial magnetic face of a stator and the second region does not correspond to the radial magnetic face of the stator, the first vertical section being positioned in the first region, the inclined section and the second vertical section being positioned in the second region.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1A is a perspective view of the rotor magnetic component structure of the present invention;

FIG. 1B is a perspective view of another embodiment of the rotor magnetic component structure of the present invention;

FIG. 2A is a partially sectional assembled view of the fan motor device of the present invention;

FIG. 2B is a stretched view of a part of the rotor magnetic component structure and the stator of the present invention;

FIG. 3A is a view showing the rotor magnetic component structure of the present invention is magnetized; and

FIG. 3B is a view showing the rotor magnetic component structure of the present invention is magnetized.

### DETAILED DESCRIPTION OF THE PREFERRED EMBODIMENTS

The embodiments of the present invention will be described hereinafter with reference to the drawings, wherein the same components are denoted with the same reference numerals.

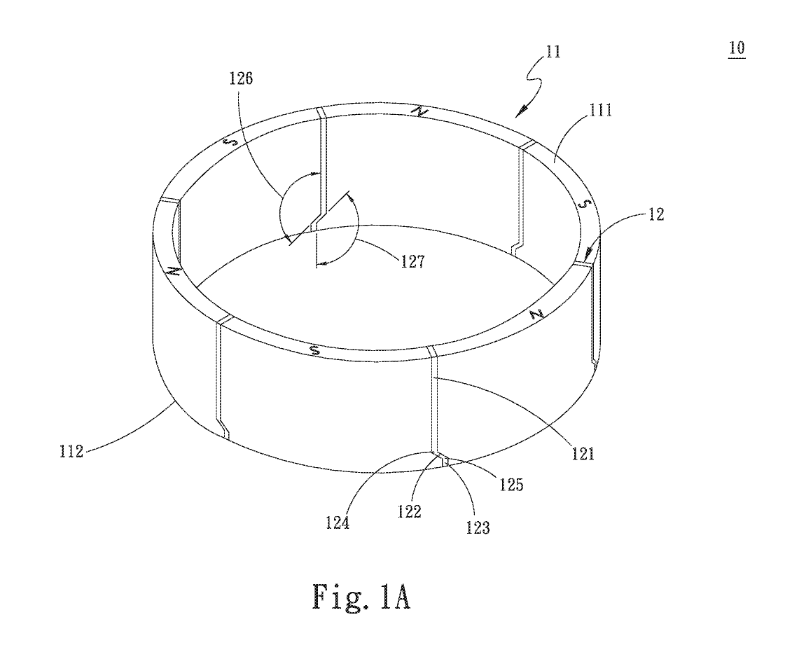

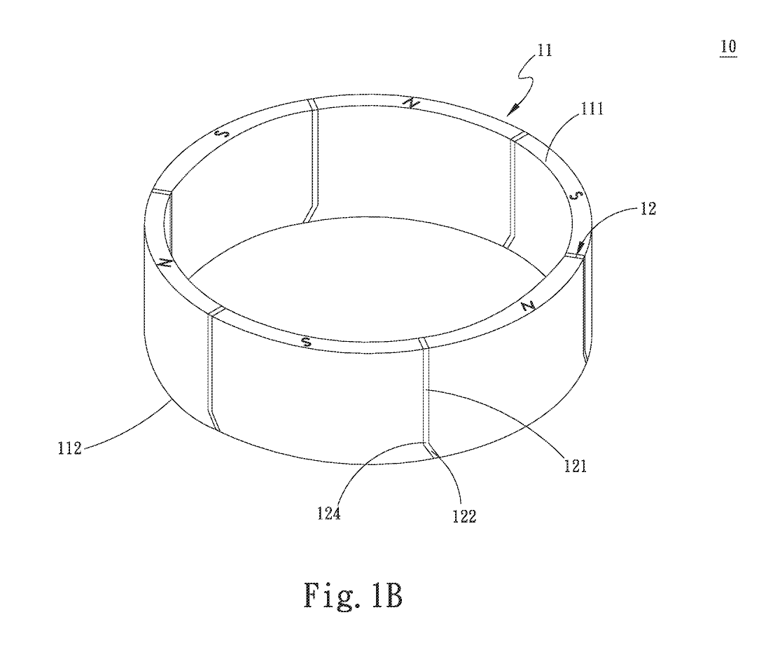

Please refer to FIG. 1A, which is a perspective view of the rotor magnetic component structure of the present invention. According to a preferred embodiment, the magnetic component 10 of the present invention includes a main body 11 in an annular form. The main body 11 has an upper side 111 and a lower side 112. The main body 11 is composed of multiple N poles and multiple S poles, which are alternately arranged. A magnetic force border line 12 is formed between each N pole and each S pole. The magnetic component 10 is selected from a group consisting of hard magnet, soft magnet and rubber magnetic powder. The magnetic component 10 is, but not limited to, made of a material selected from a group consisting of alloy magnet (Al—Ni—Co), ceramic magnet (ferrite) and rare earth magnet. In this embodiment, the magnetic force border line 12 includes a first vertical section 121, an inclined section 122 and a second vertical section 123. The first vertical section 121 vertically extends from the upper side 111 to a position near upper side of the lower side 112 and then turns and extends to form the inclined section 122. The inclined section 122 further turns toward the lower side 112 and vertically extends to the lower side 112. The first vertical section 121 is parallel to the second vertical section 123. A first turning section 124 is defined between the first vertical section 121 and the inclined section 122. A second turning section 125 is defined between the inclined section 122 and the second vertical section 123. A first angle 126 is contained between the first vertical section 121 and the inclined section 122. A second angle 127 is contained between the inclined section 122 and the second vertical section 123.

Alternatively, FIG. 1B is a perspective view of another embodiment of the rotor magnetic component 10 of the present invention. In this embodiment, the inclined section 122 of the magnetic force border line 12 obliquely extends from the first turning section 124 at lower end of the first vertical section 121 to the lower side 112 of the main body 11.

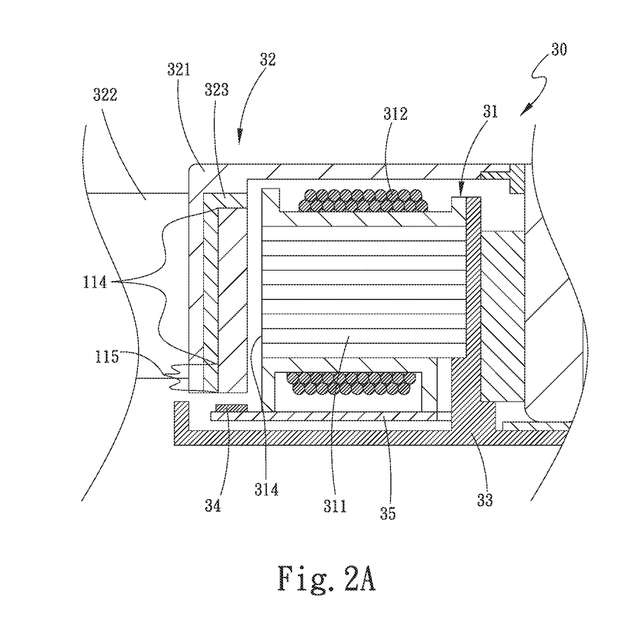

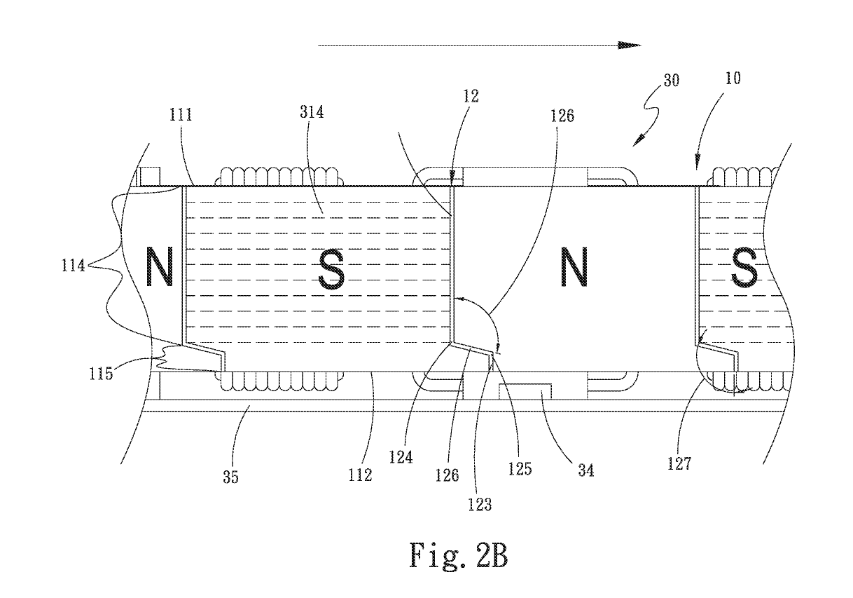

Please now refer to FIGS. 2A and 2B. FIG. 2A is a partially sectional assembled view of the fan motor device of the present invention. FIG. 2B is a stretched view of a part of the rotor magnetic component structure and the stator of the present invention. As shown in the drawings, the magnetic component 10 is applied to a fan motor device 30. The fan motor device 30 includes a stator 31 and a rotor 32. The stator 31 is disposed on a base seat 33. The stator 31 has a radial magnetic face 314 composed of multiple stacked silicon steel sheets 311. A winding assembly 312 is wound on the silicon steel sheets 311. A circuit board 35 is connected under the stator 31. At least one sensor member 34 such as a Hall sensor is disposed on the circuit board 35.

The rotor 32 corresponds to the stator 31. The rotor 32 includes a hub 321 and multiple blades 322 disposed on outer surface of the hub 321. An iron shell 323 is disposed on inner surface of the hub 321. The magnetic component 10 is disposed on inner surface of the iron shell 323 and spaced from the stator 31 corresponding to the stator 31. A first region 114 and a second region 115 under the first region 114 are defined between the upper and lower sides 111, 112 of the magnetic component 10. The first region 114 radially corresponds to the radial magnetic face 314 of the stator 31. The second region 115 does not correspond to the radial magnetic face 314 of the stator 31. However, the second region 115 is adjacent to the sensor member 34. The first vertical section 121 of the magnetic force border line 12 is positioned in the first region 114 to face the radial magnetic face 314 of the stator 31. The inclined section 122, the second vertical section 123 and the second turning section 125 of the magnetic force border line 12 are positioned in the second region 115 and spaced from the sensor member 34 in adjacency to the sensor member 34.

It should be especially noted that the inclined section 122 of the magnetic force border line 12 is inclined in the rotational direction of the main body 10. The junction between the first and second regions 114, 115 is the first turning section 124 of the magnetic force border line 12. Therefore, when the stator 31 is powered on, the radial magnetic face 314 and the magnetic component 10 magnetically act on each other to drive the rotor 32 to rotate. The first vertical section 121 of the magnetic force border line 12 in the first region 114 serves to keep the rotational efficiency between the stator 31 and the rotor 32. The inclined section 122 of the magnetic force border line 12 in the second region 115 serves to reduce the vibration caused in the commutation of N poles and the S poles of the main body 11 and enables the sensor member 34 to find the best commutation point so as to overcome the structural limitation of the conventional mechanism.

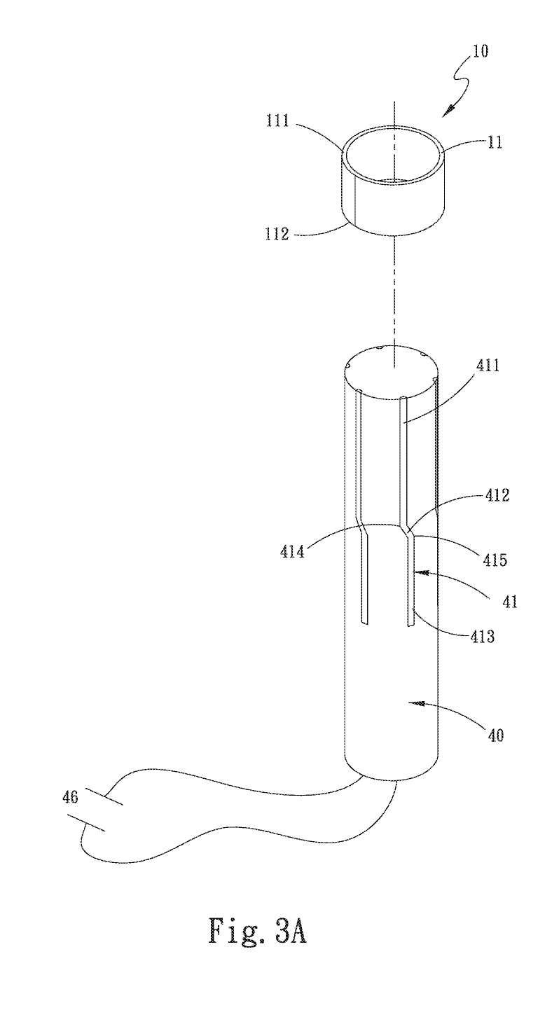

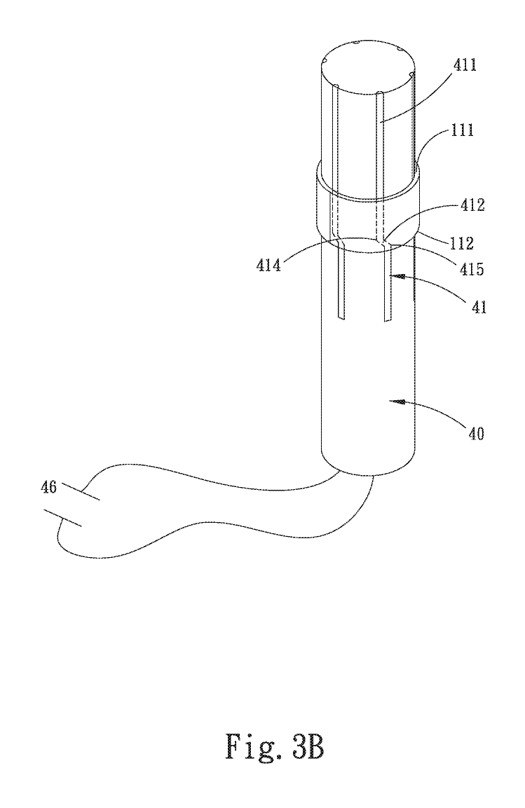

Please now refer to FIGS. 3A and 3B. FIG. 3A is a view showing the rotor magnetic component structure of the present invention is magnetized. FIG. 3B is a view showing the rotor magnetic component structure of the present invention is magnetized. In general, the magnetization methods of the magnets can be classified into two types, that is, component magnetization (CM) and post-assembly magnetization (PAM). The component magnetization means that the magnetic component has already been magnetized before assembled with the motor rotor. The post-assembly magnetization means that the non-magnetized magnetic component is mounted on the rotor and an external circuit or magnetization apparatus is used to instantaneously supply great current to produce strong magnetic field for magnetizing the magnet inside of the rotor. In the present invention, the magnetic component 10 is magnetized by means of component magnetization. First, a cylindrical magnetization apparatus 40 is provided to produce multi-pole magnetic field. Several spacing sections 41 are disposed on the outer surface of the magnetization apparatus 40 and distributed at equal angular intervals. The spacing sections 41 serve as the borders between the N pole and S pole magnetic fields. A circuit is disposed in the magnetization apparatus 40 and connected to an external power supply 46 via electrical wires for making the magnetization apparatus 40 produce magnetic fields. The spacing section 41 is such designed as to have a first vertical section 411, an inclined section 412, a second vertical section 413, a first turning section 414 and a second turning section 415 corresponding to the first vertical section 121, the inclined section 122, the second vertical section 123, the first turning section 124 and the second turning section 125 of the magnetic force border line 12 of the magnetic component 10 respectively. Before the magnetization apparatus 40 is magnetized, the nonmagnetic magnetic component 10 is previously fitted around the magnetization apparatus 40. After the magnetization apparatus 40 is powered on, the magnetization apparatus 40 produces magnetic fields to magnetize the magnetic component 10 fitted around the magnetization apparatus 40. The magnetic force border line 12 of the magnetic component 10 is formed between the N pole and the S pole (as shown in FIG. 1). Therefore, the spacing section 41 has the first vertical section 411, the inclined section 412, the second vertical section 413, the first turning section 414 and the second turning section 41 to correspondingly form the first vertical section 121, the inclined section 122, the second vertical section 123, the first turning section 124 and the second turning section 125 of the magnetic force border line 12 (as shown in FIG. 1).

In conclusion, the present invention provides a magnetic component 10 having a magnetic force border line with complex structure for the sensor member 34 to find the best commutation point. Therefore, the vibration caused in the commutation of the magnetic poles can be reduced and the efficiency of the motor can be maintained to overcome the structural limitation of the conventional mechanism.

The present invention has been described with the above embodiments thereof and it is understood that many changes and modifications in the above embodiments can be carried out without departing from the scope and the spirit of the invention that is intended to be limited only by the appended claims.

What is claimed is:

1. A rotor magnetic component structure comprising a main body having an upper side and a lower side with a bottom side surface wherein a first region and a second region under the first region are defined between the upper and lower sides, the first region radially corresponds to a radial magnetic face of a stator, and the second region does not correspond to the radial magnetic face of the stator, and a plurality of N poles and a plurality of S poles, which are circumferentially alternately arranged, a magnetic force border line formed between each N pole and each S pole, the magnetic force border line including a first vertical section arranged in the first region and an inclined section obliquely extending from a lower end of the first vertical section and arranged in the second region with a first turning section and a first angle defined between the first vertical section and the inclined section and a sensor member disposed below and corresponded to the bottom side surface to sense the inclined section.

2. The rotor magnetic component structure as claimed in claim 1, wherein the magnetic force border line further includes a second vertical section downward vertically extending from one end of the inclined section, which end is distal from the first vertical section.

3. The rotor magnetic component structure as claimed in claim 2, wherein a second turning section is defined between the inclined section and the second vertical section.

4. The rotor magnetic component structure as claimed in claim 3, wherein a second angle is defined between the inclined section and the second vertical section.

5. The rotor magnetic component structure as claimed in claim 1, wherein the inclined section is inclined in a rotational direction of the main body.

6. The rotor magnetic component structure as claimed in claim 1, wherein a junction between the first and second regions is the first turning section of the magnetic force border line.

7. A fan motor device comprising:
a stator having a radial magnetic face, a circuit board connected under the stator, and at least one sensor member disposed on the circuit board; and
a rotor corresponding to the stator, the rotor including a magnetic component having a main body having an upper side and a lower side with a bottom side surface wherein a first region and a second region under the first region are defined between the upper and lower sides, the first region radially corresponds to the radial magnetic face of the stator, and the second region does not correspond to the radial magnetic face of the stator, and a plurality of N poles and a plurality of S poles, which are circumferentially alternately arranged, a magnetic force border line formed between each N pole and each S pole, the magnetic force border line including a first vertical section arranged in the first region and corresponding to the radial magnetic face of the stator and an inclined section obliquely extending from a lower end of the first vertical section and arranged in the second region with a first turning section and a first angle defined between the first vertical section and the inclined section, the sensor member disposed below and corresponded to the bottom side surface to sense the inclined section.

8. The fan motor device as claimed in claim 7, wherein the magnetic force border line further includes a second vertical section downward vertically extending from one end of the inclined section, which end is distal from the first vertical section.

9. The fan motor device as claimed in claim 8, wherein a second turning section is defined between the inclined section and the second vertical section.

10. The fan motor device as claimed in claim 9, wherein a second angle is defined between the inclined section and the second vertical section.

11. The fan motor device as claimed in claim 10, wherein the inclined section is inclined in a rotational direction of the main body.

12. The fan motor device as claimed in claim 7, wherein a junction between the first and second regions is the first turning section of the magnetic force border line.
